(19) United States
(12) Patent Application Publication
(10) Pub. No.: US 2017/0068974 A1
(43) Pub. Date: Mar. 9, 2017

(54) System For Obtaining Customer Feedback Using a Scannable Code

(71) Applicant: Jeffrey Firestone, Boca Raton, FL (US)

(72) Inventor: Jeffrey Firestone, Boca Raton, FL (US)

(73) Assignee: SCANNATION CORPORATION, Boca Raton, FL (US)

(21) Appl. No.: 14/092,924

(22) Filed: Nov. 28, 2013

(51) Int. Cl. G06Q 30/02

(52) U.S. Cl. CPC G06Q 30/0203; G06Q 30/0282

(57) ABSTRACT

The present invention is directed to a system for gathering customer feedback or information via a portable data input and transfer device, such as a smart phone or tablet computer, capable of scanning a data representation or code associated with a survey or feedback form, presenting the user with said survey or feedback form, and transferring the feedback or information entered by the user to a server.

### CROSS-REFERENCE TO RELATED APPLICATIONS

This application claims priority to provisional application No. 61/730,089, filed Nov. 27, 2012.

### STATEMENT REGARDING FEDERALLY SPONSORED RESEARCH OR DEVELOPMENT

Not Applicable

### BACKGROUND OF THE INVENTION

Businesses and organizations seek customer feedback for numerous reasons, including to evaluate the quality of goods or services offered, to tailor goods and services to customer preferences, to monitor the effectiveness of employees in meeting customer needs, and to better meet customer expectations.

One traditional method for obtaining customer feedback is to provide comment cards or evaluation forms to be completed after the good or service is consumed. A problem with this approach, however, is that it often fails to capture or reflect a typical customer's experience. For example, restaurant patrons may only be motivated to fill out a comment card if the food or service is extremely good or poor. It is know that the experience of customers most likely to fill out a comment card is often atypical, rendering such feedback unreliable in helping to guide the business or organization. Moreover, response rates for comment cards and other evaluation forms are typically low, which limits the ability of the provider to obtain adequate feedback.

Customer feedback can also be obtained by telephone or online surveys. However, such surveys are expensive to conduct, may not reach the desired customer base, and typically have low response rates.

One technique businesses and organizations have used to increase the reliability and amount of customer feedback is to offer customers a reward, such as frequent flier miles or a future discount, for completing a comment card, participating in a survey, or providing online feedback. This incentive-based approach increases response rates, resulting in a more informative and representative sample than would otherwise be the case. However, such incentive-based approaches require infrastructure to identify the customer, process the data, and distribute the reward, often involving steps such as manually entering customer information and mailing a coupon to a particular address. Additionally, such incentive-based approaches often require systems like reward cards or special reward programs the customer needs to sign up for, increasing cost and limiting participation. Moreover, depending on the goods or services involved, it may be inconvenient for the customer to provide feedback at the time and place the good or service is purchased or utilized due to, for example, lack of a writing implement or a convenient place to enter information. It may also be inconvenient to capture or process feedback due to, for example, the need to serve other customers. Processing the feedback may further require physical transfer and manual entry of the form used as well as interpretation of hand-written information.

The present invention is directed to a novel system for obtaining reliable customer feedback that mitigates or eliminates many of the difficulties associated with prior art approaches. It utilizes common tools, such as smart phones and matrix codes, to enable customers to conveniently provide feedback and, optionally, obtain a reward at approximately the time and place where the good or service is purchased or consumed. In particular, the present invention is directed to a system for gathering customer feedback via a data input and transfer device, such as a smart phone or wireless tablet computer, capable of scanning a data representation or code, such as a matrix barcode or graphic, associated with a survey or other feedback form. In a preferred embodiment, the customer is further presented with a reward once feedback has been provided.

### SUMMARY OF THE INVENTION

The present invention is directed to a novel system for gathering customer feedback using a portable data input and transfer device, such as a customer's smart phone or tablet computer with wireless communication capability, that interacts with a scannable representation or code, such that upon scanning the user is directed to a fillable form or survey page where feedback or information regarding a good, service, or the customer himself can be entered. The business or organization seeking feedback or information provides the customer a scannable representation or code, such as a Quick Response Code™ or other matrix barcode or scannable graphic, that can be scanned by the data input and transfer device to bring up a feedback template, which the device can be used to fill out. In one embodiment, the scannable representation can be processed by the device to direct a browser or other application to a particular internet address, where a provider's feedback form is located. The data representation or code is associated with a good or service for which the provider desires feedback, and information embedded in the code is used to present a survey or other feedback form to fill out via the interface of the data input and transfer device.

While matrix bar codes are a common form of scannable representation, the invention is directed to any form of representation that can be scanned by a portable data input and transfer device to lead to a fillable feedback form. For example, the invention would also apply to an augmented reality representation such as a hologram encoded with information that can be scanned by a portable data input and transfer device and resolves to a particular feedback form.

In one embodiment, a QR code can be used that contains information resolvable as an internet address where a predefined survey concerning a product or service is hosted. When the code is scanned, a browser is directed to the internet address and the customer is presented with a survey to fill out. Once the survey has been filled out, a copy of the completed survey can be stored, processed immediately, or transmitted according to the needs of the survey provider. Use of the QR code and Internet address enables the survey system to be platform independent, as customers can use any device capable of reading the code and accessing the internet, irrespective of whether the device uses an Android™, Blackberry™, iPhone™, Windows™, or other operating system. One such system has been implemented by the assignee under the name ScanBites®.

Alternatively, the data representation or code can be processed by a dedicated software application installed on the data input and transfer device. In this case, information from the data representation or code is again associated with a feedback form, but the form may be stored locally and need not be accessible via HTML or other browser-based language. Once the survey form is completed, a copy of the data can be wirelessly transferred to the provider or an intermediary, such as a marketing, advertising, or survey firm. In one embodiment, the software application can present the user with a keyboard or alpha-numeric template and the user can input a series of numbers or letters to access a version of the customer survey platform.

Both embodiments permit the collection of real time customer feedback at the point of sale or use of the relevant product or service. Thus, the customer is able to provide feedback at the point of service while the experience is fresh in their memory, ensuring more accurate feedback. Additionally, the business is able to obtain the feedback as soon as it has been transmitted from the user. This removes much of the delay associated with prior art techniques for obtaining customer feedback. Responses are available in real time and the form can be dynamically updated with new or additional questions or content to meet the needs of the business or service provider seeking feedback. The feedback form presented to the user can be further defined based on pre-established rules. For example, rules can be implemented in the software to offer a different feedback form based on the time of day, the day of week, the GPS location of the customer, and/or the type of browser used.

The system can also be engineered to provide an instant reward to the customer as an incentive for providing feedback. The reward can even be applied to the service just used, as with a discount applied to a hotel stay based on feedback provided prior to checkout. That is, once a completed survey has been saved or submitted, a discount coupon or credit for the good or service or a related good or service may be provided to the customer via an HTML link, text message, email, or other means, or an account associated with the customer may be credited with funds, frequent flier miles, loyalty points, or other reward. The customer may also be given an option to make a reservation or share the experience or review with others. The ability of the invention to enable a provider to offer a timely reward without undue overhead, and therefore to encourage broad and detailed feedback, is desirable to businesses and organizations seeking reliable information to help guide their products and services. Furthermore, the reward system can be administered by the provider of the feedback system based on the information provided by the customer, such as home or email address. Also, the software implementing the present invention can be configured to permit the user to pay for the product or service via credit or debit card, either before or after providing feedback.

As part of logging into or filling out the form, or as a requirement for obtaining a reward, a customer may optionally be requested to provide identifying or contact information, such as name, address, email, phone or text number, age, sex, etc. Such information may be useful for maintaining contact with the customer, analyzing the feedback provided, or building a database for marketing purposes. For example, it can be used to determine if the product is more highly rated by young men or older woman, information that can be used to market or refine the product or service.

All or part of such background information may be stored as a cookie or file useable by a browser-based or application-based system. Such a cookie or file increases the convenience of filling out future forms or surveys by eliminating the need for the customer to reenter the information. Information about prior feedback the customer has provided or other products and services the customer has used may be stored in such a cookie or file and can be used to analyze the feedback or to tailor the reward offered for providing feedback. Also, many smart phones and tablet computers have the capability to provide the location of a customer via Global Positioning System (GPS) or other means. The present invention is capable of capturing such location data along with the feedback information, which enables providers to track survey responses by geographic location. Also, the present invention can identify and provide information about which operating system (e.g., Android™, Blackberry™, iPhone™, Windows™) and browser software (e.g., Apple™, Microsoft™, Opera™) a customer is using.

The present invention further offers providers the ability to edit and update survey forms to capture new or different information by editing, in a manner akin to a website, the questions presented to users. Additionally, different questions and even entirely different forms can be selectively presented to different customers based on their answers to prior questions or the information contained in the customer's cookie or background data file. Moreover, different forms can be randomly presented to capture feedback regarding different aspects of customer experience or, for example, to test new feedback questions. For example, every fourth survey presented to an airline traveler could be focused on information about entertainment and meal offerings as opposed to more general questions.

The present invention combines and draws on known technologies, such as matrix codes, smart phones, and the internet, in new ways to help solve the persistent problem of obtaining high quality customer feedback in a convenient manner without undue expense or overhead.

### PREFERRED EMBODIMENT

At this time, the preferred embodiment involves using a smart phone as the portable data input and transfer device. The scannable representation is a QR™ Code that can be scanned by a smart phone application and resolved into a internet address where a fillable feedback form is presented via an internet browser. The form is then filled out using the input system of the phone. Once the form is complete a copy is saved on the remote server for transfer to the business or organization seeking feedback. Upon completion the browser is directed to a web page containing a scannable coupon for the good or service for which feedback has been provided.

What is claimed is:

1. A system for gathering customer feedback and/or information via a portable data input and transfer device with optical scanning capability, where:
the device is used to scan a scannable representation or code; and
after scanning the scannable representation or code, the customer is presented with a fillable form or survey page; and
after the customer enters feedback and/or information into the fillable form or survey page, the feedback and/or information is transferred from the device to a server for storage, evaluation, and/or further processing.

2. The system of claim 1, where the customer receives a reward, such as a discount or credit toward a future purchase, after providing feedback and/or information.

3. The system of claim 1, where the scannable representation or code causes the portable data input and transfer device to display a web site containing the fillable form or survey page.

4. The system of claim 1, where the scannable representation or code is scanned using a software application, where said software application displays the fillable form or survey page.

5. The system of claim 1, where said feedback and/or information is wirelessly transferred from the device to the server.

6. The system of claim 1, where the scannable representation or code is a QR Code.

7. The system of claim 2, where the scannable representation or code is a QR Code.

8. The system of claim 2, where the system can be configured to enable the user to pay for the product or service via credit or debit card before or after providing feedback and/or customer information.

9. A method for gathering feedback and/or information via a portable data input and transfer device with an optical scanner, comprising:
presenting the user with a scannable representation or code; and
once the user scans the scannable representation or code, presenting the user with a fillable form or survey; and
after the customer enters feedback and/or information into the fillable form or survey, transferring the feedback and/or information to a server for storage, evaluation, and/or further processing.

10. The method of claim 9, where the user receives a reward, such as a discount or credit toward a future purchase, after providing feedback and/or information.

11. The method of claim 9, where said feedback and/or information is wirelessly transferred from the device to the server.

12. The method of claim 9, where the scannable representation or code causes the portable data input and transfer device to display a web site containing the fillable form or survey page.

13. The method of claim 9, where the scannable representation or code is scanned using a software application, where said software application displays the fillable form or survey page.

14. The method of claim 9, where the scannable representation or code is a QR Code.

15. The method of claim 10, where the scannable representation or code is a QR Code.

16. The method of claim 10, where the user is presented with the ability to pay for the product or service via credit or debit card, either before or after providing feedback and/or customer information.
